(19) United States
(12) Patent Application Publication
(10) Pub. No.: US 2024/0152399 A1
(43) Pub. Date: May 9, 2024

(54) System and Method of Context Oriented Quotas (CoQ) In Cloud Systems

(71) Applicant: Google LLC, Mountain View, CA (US)

(72) Inventor: Dhandapani Shanmugam, Bangalore (IN)

(21) Appl. No.: 17/980,070

(22) Filed: Nov. 3, 2022

(51) Int. Cl. G06F 9/50; G06F 11/34

(52) U.S. Cl. CPC G06F 9/505; G06F 9/5044; G06F 9/5072; G06F 11/3409

(57) ABSTRACT

The technology is directed to systems and methods for adjusting computing resource quotas based on metrics associated with or corresponding to a cloud environment. The metrics corresponding to computing resources used by a cloud environment may be received. The received metrics may be input into a machine learning model, which may generate, based on the received metrics, one or more predicted quotas for the computing resources used by the cloud environment. The computing resource quotas may be adjusted based on the predicted quotas generated by the machine learning model.

### BACKGROUND

When managing a cloud environment, ensuring there are sufficient computing resources to handle all demands of the cloud environment within a cloud service is often a focus of an administrator. To avoid budget overruns resulting from provisioning computing resources from a cloud service, administrators, or other such users, may set up financial governance rules within the cloud service. In this regard, cloud services may provide administrators with the option to set quotas for a variety of services. The quotas allow the level of computing resources to be dynamically adjusted to meet the demands of the cloud environments up to the limits of the quotas. The quotas may also be used to establish guardrails and safeguard against budget overruns caused by unforeseen costs being incurred by provisioning more computing resources from the cloud service than expected.

Existing quota systems within cloud environments typically require manual intervention to adjust the quotas of the computing resources when demand increases or a quota has been reached. As such, an administrator or other user may need to continuously monitor the cloud environment or react to alerts generated by monitoring software to adjust the quotas within the cloud service to meet demand. Such manual monitoring and adjusting of the quotas of the services of cloud environments may be burdensome and costly. In addition to continually monitoring quotas, mishaps or missed alerts may result in the cloud environment not meeting demand, potentially resulting in revenue loss and degraded or failed end-user experiences.

### BRIEF SUMMARY

One aspect of the technology described herein is directed to a method for adjusting quotas. The method may include receiving, by a first computing device, one or more metrics corresponding to computing resources used by a cloud environment; providing, by the first computing device, the one or more metrics to a machine learning model; receiving, by the first computing device from the machine learning model, one or more predicted quotas for the computing resources; and adjusting, by the first computing device, computing resource quotas based on the one or more predicted quotas.

In some instances, the first computing device is a cloud service server.

In some instances, the computing resources are provided by a cloud service.

In some instances, the cloud environment is an application or website implemented by the computing resources of the cloud service.

In some instances, the one or more metrics include traffic volume of the cloud environment.

In some instances, business contexts data corresponding to the cloud environment, may be received. The business contexts data may be provided to the machine learning model.

In some examples, the business contexts data may comprise business event data including information about upcoming sales, advertisements, or promotions being provided by a business associated with the cloud environment.

In some examples, the business contexts includes geographic event data including information corresponding to happenings in particular locales that may affect the cloud environment.

In some examples, the business event data is retrieved by a business event agent executing on the first computing device.

In some examples, the geographic event data is retrieved by a geo agent executing on the first computing device.

Another aspect of the technology is directed to a system. The system may include a processor and memory storing instructions that, when executed by the processor, configure the system to receive one or more metrics corresponding to computing resources used by a cloud environment, provide the one or more metrics to a machine learning model, receive from the machine learning model, one or more predicted quotas for the computing resources, and adjust computing resource quotas based on the one or more predicted quotas.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates an aspect of the subject matter in accordance with aspects of the disclosure.

FIG. 2 illustrates an aspect of the subject matter in accordance with aspects of the disclosure.

FIG. 3 illustrates an example of generating predicted quotas in accordance with aspects of disclosure.

FIG. 4 illustrates an example of updating quotas based on predicted quotas in accordance with aspects of the disclosure.

FIG. 5 is a flow chart 500 illustrating a method for adjusting quotas in accordance with aspects of the disclosure.

### DETAILED DESCRIPTION

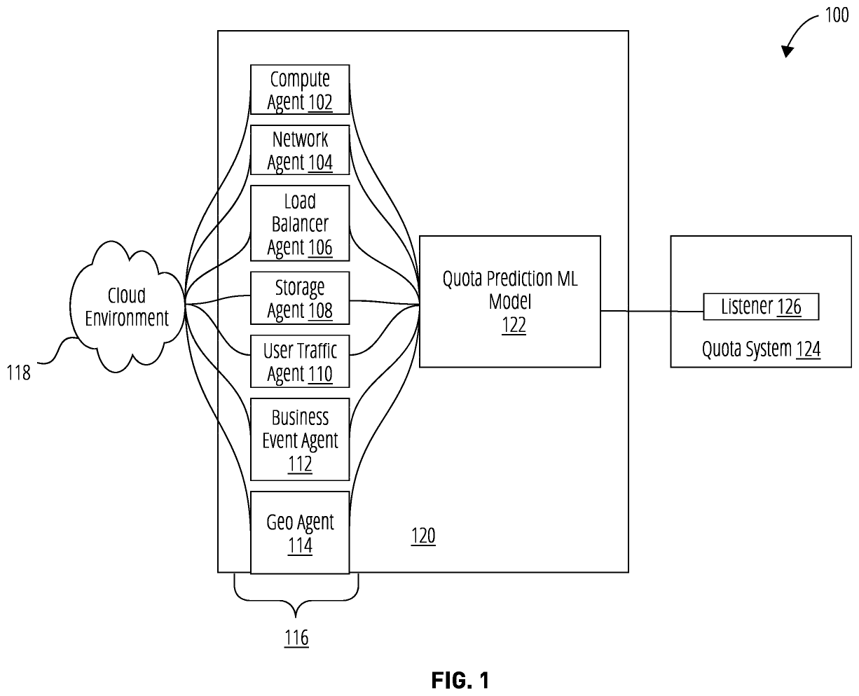

FIG. 1 is a diagram showing an example implementation 100 of a quota prediction system 120 for adjusting the computing resource quotas for a cloud environment 118. The quota prediction system 120 may be used to manage the quotas associated with computing resources provided by a cloud computing platform when implementing cloud environments, such as cloud environment 118. As illustrated, the quota prediction system 120 may collect metrics corresponding to the cloud environment 118 via agents. The collected metrics may include the traffic volume of the cloud environment 118 and computing resource usage by the cloud environment 118, as well as business contexts associated with the cloud environment 118. The collected metrics be passed to a quota prediction ML model 122. The quota prediction ML model 122 may use the collected metrics to predict quotas for the business contexts using the collected metrics, and pass these predicted quotas to the quota system 124. A listener 126 within the quota system may receive the predicted quotas and instruct the quota system 124 to update the computing resource quotas for the cloud environment 118 based on the predicted quotas. In some instances, updating the computing resource quotas for the cloud environment 118 may include limiting an increase of the computing resource quotas based on financial limits set for the cloud environment 118, as described further herein.

The cloud environment 118 may be an application or collection of applications implemented using computing resources of a cloud computing platform. For instance, the cloud environment 118 may be a website, database, application, or other such service offered or operated by an entity, such as an individual, company, business, etc. For instance, and without limitation, the cloud environment 118 may be an e-commerce website, a social media website, an online game, a web app, etc.

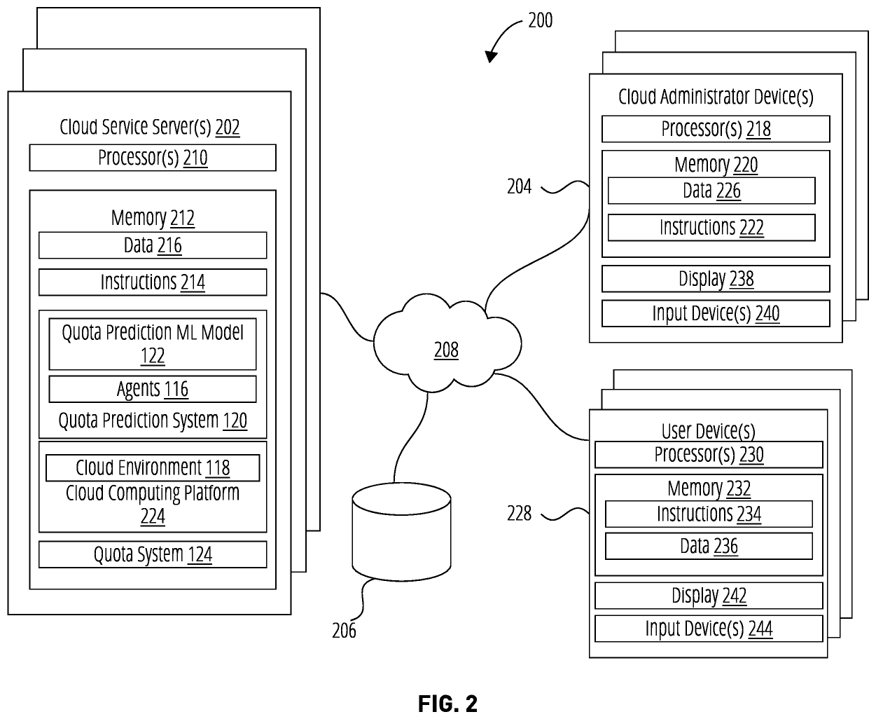

In operation, the cloud environment 118 may leverage computing resources provided by a cloud computing platform, such as cloud computing platform 224 of FIG. 2. In this regard, the cloud computing platform 224 may be a platform that provides computing resources to implement cloud environments, such as cloud environment 118. The cloud computing platform 224 can perform a variety of functions corresponding to any number of services that can be generally grouped according to different paradigms, e.g., IaaS, SaaS, and PaaS. The cloud computing platform 224 can provide a variety of different services that perform a task on computing resources.

As used herein, computing resources may refer to hardware, such as memory, processors, storage devices, etc., offered by cloud computing platform 224, as well as applications running thereon. Computing resources may also refer to a number and/or quality of network connections over a network to and from the cloud computing platform 224. For instance, computing resources may include hardware and software of servers, such as cloud service servers 202. Computing resources can be quantified in different ways, such as by a number of clock cycles for some selected processors, a period of time for using processors and/or storage devices of the platform, or general unrestricted access to computing resources at a throttled rate of processing/bandwidth.

The cloud computing platform 224 can provide specialized hardware as part of the computing resources. For example, ASICs, such as tensor processing units (“TPUs”) within the cloud service servers 202, can receive data and processing parameters to process the received data on the specialized hardware according to the processing parameters. The cloud computing platform 224 can provide at least part of the storage capacity of the storage device 206 for a cloud environment 118 to store data on. Similarly, the cloud computing platform 224 can establish or otherwise provide one or more virtual machines or other forms of abstraction for use by the cloud environment 118.

The cloud computing platform 224 may provide a number of application programming interfaces (“APIs”), which can define interfaces for users, such as administrators of cloud environments to communicate with services hosted by the cloud service servers 202 on which the cloud environments are executing. The cloud computing platform users can invoke one or more function calls defined in a corresponding API, using source code provided to the cloud computing platform 224, such as by an administrator or user using a computing device. In turn, when the source code is executed, the cloud computing platform 224 can automatically execute services invoked through the one or more function calls, according to different parameter values specified in the calls.

The cloud computing platform 224 may be maintained by an individual or an entity that is different or the same as the entity maintaining and/or owning the cloud environment 118. The cloud computing platform 224 may be configured to offer services to the users of the cloud computing platform 224 for free or at cost to entities hosting cloud environments on the cloud computing platform 224. The cloud computing platform 224 may offer computing resources to cloud environments 118 relative to a monetary cost. Administrators or other managers of the cloud environment 118 may pay for the use of the computing resources provided by the cloud computing platform 224, such as the use of storage capacity, processing power, etc.

Referring to FIG. 1, the quota system 124 may define quotas for computing resources used by the cloud environment 118. In this regard, cloud services may provide administrators or other such users of the cloud environment 118 and/or the cloud computing platform 224 on which the cloud environment 118 is executed with the ability to set quotas for a variety of computing resources. For instance, the quota system 124 may provide a graphic user interface (GUI) that administrators or other such users may access, such as through a network, to review, adjust, and/or set quotas for computing resources provided by the cloud computing platform 224. The quotas may allow the level of computing resources provided by the cloud computing platform 224 to be dynamically adjusted to meet the demands of the cloud environment up to the limits of the quotas set by the quota system 124. As discussed herein, the quotas may also be used to establish guardrails and safeguard against budget overruns caused by unforeseen costs being incurred by provisioning more computing resources from the cloud computing platform 224 than expected.

The agents 116 of the quota prediction system 120 may include any or all of a compute agent 102, network agent 104, load balancer agent 106, storage agent 108, user traffic agent 110, business event agent 112, and geo agent 114. The agents may monitor, such as by being provided, retrieving, or otherwise gathering, various metrics associated with the computing resources used by the cloud environment 118. The agents 116 may be daemons that execute on a server, such as cloud service server 202. Additionally, the agents may monitor other metrics associated with business contexts associated with the cloud environment. The agents 116 may monitor metrics at predetermined intervals, such as every five minutes, or more or less, or upon receipt of a request or a trigger, such as a request from a user or a particular event occurring.

The metrics associated with the computing resources used by the cloud environment 118 may include compute metrics, network metrics, load balancing metrics, storage metrics, and user traffic metrics. The metrics associated with business contexts associated with the cloud environment 118 may include business event data and geographic event data. Compute metrics, which may be monitored by the compute agent 102 may include information associated with the use of processing components provided by the cloud computing platform 224 by the cloud environment 118, such as the use of processors, virtual machines, memory, etc.

Network metrics, which may be monitored by the network agent 104 may include information associated with the use of the network, such as network 208 (shown in FIG. 2), by the cloud environment 118. For example, network metrics may include the number of network connections, data transmitted and received over the network connections, etc.

Load balancing metrics, which may be monitored by the load balancer agent 106, may include information about the locations where the cloud environment 118 is being accessed or otherwise used. The locations and/or identification of systems being utilized by the cloud environment 118 and the load of these systems. For instance, the load balancing metrics may include an identification of and processing load cloud service servers 202 are processing to provide the cloud environment 118. For instance, a first cloud service server 202 may be providing 75% of processing for the cloud environment 118 and a second cloud service server 202 may be providing the other 25%. Load balancing metrics may also provide information about virtual machines or other such computing objects providing processing for the cloud environment 118.

Storage metrics, which may be monitored by the storage agent 108, may include information about the amount of storage being used by the cloud environment 118. For instance, the storage metrics may indicate the cloud environment is using 10 TB of data on a first storage device and 2 TB of data on a second storage device.

User traffic metrics, which may be monitored by the user traffic agent, may include information about the number of users accessing or otherwise using the cloud environment 118 over periods of time. The user traffic metrics may include information corresponding to any number of time periods. For instance, the user traffic metrics may include information corresponding to user traffic over a minute period, a five-minute period, an hour period, a daily period, etc.

Business event data, which may be considered part of the business contexts of the cloud environment 118, may be monitored by the business event agent 112. Business event data may include information corresponding to happenings that may affect the cloud environment. For instance, for a cloud environment that provides ecommerce, the business event data may include information about upcoming sales, advertisements, or promotions associated with the cloud environment.

Geographic event data, which may be considered part of the business contexts of the cloud environment 118, may be monitored by the geo agent 114. Geographic event data may include information corresponding to happenings in particular locales that may affect the cloud environment. For instance, for a cloud environment that provides ecommerce, the geographic event data may include information related to holidays or other such events happening in a particular locale that may drive higher user traffic to the ecommerce cloud environment than normal.

As further illustrated in FIG. 1, the quota prediction system 120 may include a quota prediction ML model 122. The quota prediction ML model 122 may be a supervised or unsupervised machine learning model configured to determine predicted quotas for given metrics, including business contexts. These predicted quotas may be context-oriented quotas (CoQs) that are used by the quota system 124 to adjust the quotas associated with a cloud environment by proactively and continuously deducing the context of the cloud environment such as business events, user traffic, infrastructure behavior under typical, non-Distributed Denial Of Service (DDos) attack circumstances, etc. For instance, the quota prediction ML model 122 may output predicted quotas for metrics including given user traffic to the cloud environment, given active infrastructure usage by the cloud environment (e.g., virtual CPU cores and memory) and a given business context for the cloud environment, such as an annual sales event. In one example, the quota prediction ML model 122 may receive metrics associated with business contexts associated with the cloud environment 118 including business event data and geographic event data, such as user traffic and compute metrics over the past week and information about a weeklong sale starting in one day in the United States. Based on this input, the quota prediction ML model 122 may determine x % of increased computing resources are required for the next week in the United States.

Training of the quota prediction ML model may be performed by collecting a set of training data comprising metrics associated with computing resources provided by cloud services to various cloud environments, including business contexts. Using the set of training data, the quota prediction ML model may be trained using, for example, linear regression models.

The quota prediction ML model 122 may be software executing on or within the quota prediction system 120 that receives, retrieves, or is otherwise provided with metrics associated with the computing resources used by the cloud environment 118 and monitored by the agents 116. The quota prediction ML model 122 and/or another component of the quota prediction system 120 may monitor the agents 116 for metrics at predetermined intervals, such as every five minutes, or more or less, or upon receipt of a request or a trigger, such as a request from a user or a particular event occurring. Alternatively, the agents 116 may provide the metrics to the quota prediction ML model 122. For instance, the agents may provide metrics at predetermined intervals or at the request of the quota prediction ML model 122 or another such component of the quota prediction system 120. For instance, the compute agent 102 may provide compute metrics every minute and the network agent 104 may provide network metrics every hour.

As further illustrated in FIG. 1, the quota system 124 may include a listener 126. The listener 126 may be configured to monitor for predicted quotas from the quota prediction system 120. In this regard, the listener 126 may be software executing on or within the quota system 124 that receives, retrieves, or is otherwise provided with predicted quotas from the quota prediction system 120. The quota system 124 may monitor the quota prediction system 120 for predicted quotas generated by the quota prediction ML model 122 at predetermined intervals, such as every five minutes, or more or less, or according to a configurable schedule. In some instances, the quota system 124 may monitor the quota prediction system 120 for predicted quotas generated by the quota prediction ML model 122 upon receipt of a request or a trigger, such as a request from a user or a particular event occurring.

FIG. 2 illustrates the implementation of the quota prediction system 120, quota system 124, and the cloud computing platform 224 on cloud service servers 202 of cloud system 200. As further shown in FIG. 2, the cloud environment 118 is implemented by the cloud computing platform 224. The cloud system 200 can include one or more cloud service servers 202, one or more storage devices 206, one or more user computing devices 228, and/or one or more cloud administrator devices 204. For ease of description, processes and systems according to some aspects of this disclosure will be described as if implemented on a single cloud service server 202, user computing device 228, or cloud administrator device 204, but some or all components of the cloud system 200 can be implemented across different computing devices in one or more physical locations

User computing devices 228 and cloud administrator devices 204 may access the cloud environment 118 and/or the quota prediction system 120 via network 208. For clarity and ease of description, processes and systems according to some aspects of this disclosure, including the quota prediction system 120 and cloud environment 118, will be described as if implemented on a single cloud service server 202, but some or all processes and systems of the cloud system 200 can be implemented across different cloud service servers 202 in one or more physical locations. Although FIG. 2 illustrates the quota prediction system 120 and quota system 124 as being executed by the cloud service servers 202, the quota prediction system 120 and quota system 124 may execute by other platforms, servers, and computing devices, such as cloud administrator devices 204, user computing devices 228, third-party servers, etc.

The cloud service servers 202 can include one or more processors 210 and memory 212. The memory 212 can include instructions 214 and data 216. The instructions 214 are one or more instructions written in a computer programming language that when executed by the cloud service servers 202, cause the cloud service servers 202 to perform one or more actions. The data 216 can include data that is retrieved, processed, or generated by the cloud service servers 202 as part of one or more actions performed by the cloud service servers 202 when the instructions 214 are executed. Separately or as part of the instructions 214, the memory 212 can include instructions and data structures that when executed by the cloud service servers 202 cause the cloud service servers 202 to implement the cloud computing platform 224 and cloud environment 118, quota system 124, and/or quota prediction system 120 according to some aspects of the disclosure.

The user computing devices 228 can also include one or more processors 230, memory 232 storing instructions 234 and data 236. The user computing devices 228 can additionally include a display 242 and input devices 244, e.g., touchscreen, keyboard, mouse, etc. Cloud Administrator devices 204 may be configured similarly to user computing devices 228. In this regard, cloud administrator devices 204 may include processors 218, memory 220 storing instructions 214 and data 226, display 238, and input devices 240.

The processors 210, 218, and 230 of the cloud service server 202, cloud administrator device 204, and user computing device 228 (collectively, the “computing devices”), respectively, can be a combination of any kind of processor, e.g., central processing units (“CPUs”), graphics processing units (“GPUs”), or application-specific integrated circuits (“ASICs”). The memory 212, 220, and 232 of the computing devices can also be a combination of any kind, e.g., volatile or non-volatile, including RAM, solid state memory, or hard disk.

The cloud service servers 202, cloud administrator devices 204, and user computing devices 228 can communicate according to any communication protocol over a network, such as network 208. The network 208 can be a local- or wide-area network, or be the Internet itself. The computing device can communicate according to any communication protocol, e.g., SHH, HTTP(S), or FTP. The cloud system 200 can also include one or more storage devices 206 communicatively coupled to the computing devices over the network 208. The storage devices 206 can store data generated by the cloud environment 118, cloud computing platform 224, or other applications and systems within the cloud system 200.

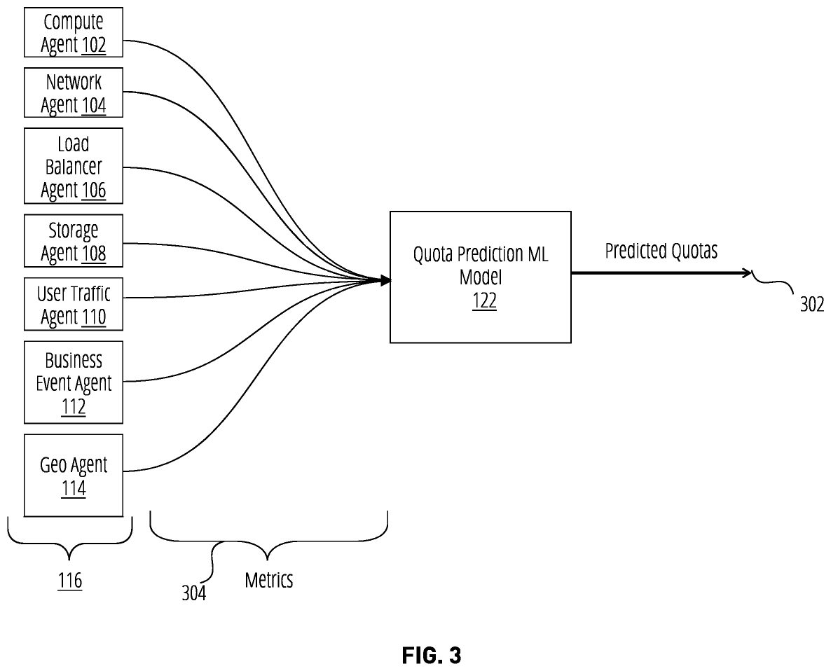

FIG. 3 illustrates the agents 116, including compute agent 102, network agent 104, load balancer agent 106, storage agent 108, user traffic agent 110, business event agent 112, and geo agent 114 passing, or otherwise providing metrics to the quota prediction ML model 122. As illustrated, the quota prediction ML model 122 may determine predicted quotas 302 based on the received metrics 304. Although FIG. 3 illustrates metrics 304 being provided by all of the agents 116, metrics 304 may be provided by any number of agents 116.

As explained herein, the collected metrics may include the traffic volume of the cloud environment and computing resource usage by the cloud environment, as well as business contexts associated with the cloud environment. For example, the user traffic agent 110 may provide to the quota prediction ML model 122, user traffic metrics (traffic volume metrics), such as the number of daily active visitors to a cloud environment, such as cloud environment 118. Additionally, the network agent 104 and storage agent 108 may provide network metrics and storage metrics, respectively. Network metrics may include the amount of data transferred over a network to and from the cloud environment 118 over a period of time and storage metrics may include the amount of storage used by the cloud environment 118 over the period of time. Additionally, the business event agent 112 and geo agent 114 may provide business contexts, such as the dates of an upcoming sale event and where the sale event will occur, respectively.

Using the provided metrics, the quota prediction ML model 122 may generate predicted quotas 302. The predicted quotas 302 may correspond to expected computing resource usage by the cloud environment 118 over an upcoming period of time, such as during the sale event.

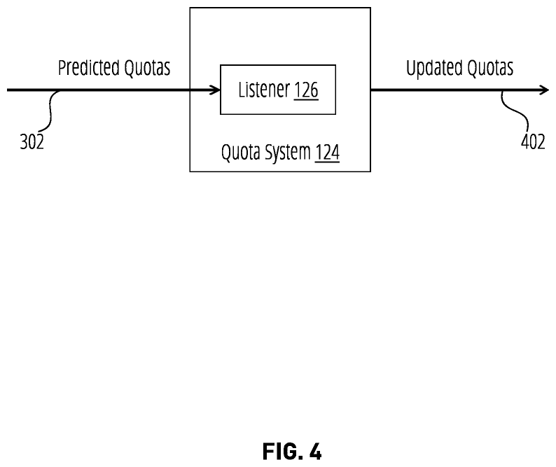

FIG. 4 illustrates predicted quotas 302 being passed (or retrieved) by listener 126 of the quota system 124. The quota system 124 may then generate updated quotas 402, which can be used to update the computing resource quotas for the cloud environment 118 based on the predicted quotas. Although FIG. 4 illustrates the updated quotas 402 being passed out of the quota system 124, the quota system 124 itself may use the updated quotas 402 to update the computing resource quotas for the cloud environment 118. In some instance, the quota system 124 may limit the maximum and or minimum computing resource quotas for a cloud environment. These maximums and/or minimums may be set automatically and/or manually, such as by an administrator using cloud administrator device 204. In such cases, the quota system 124 may limit the computing resource quotas for the cloud environment to the set maximum and/or minimum limits, even if the updated quotas 402 would be more or less than the maximum and minimum limits, respectively. By setting maximum and/or minimum limits for certain computing resource quotas, the operating expenses incurred by the cloud environment 118 can be limited, even in times of high demand for the cloud environment.

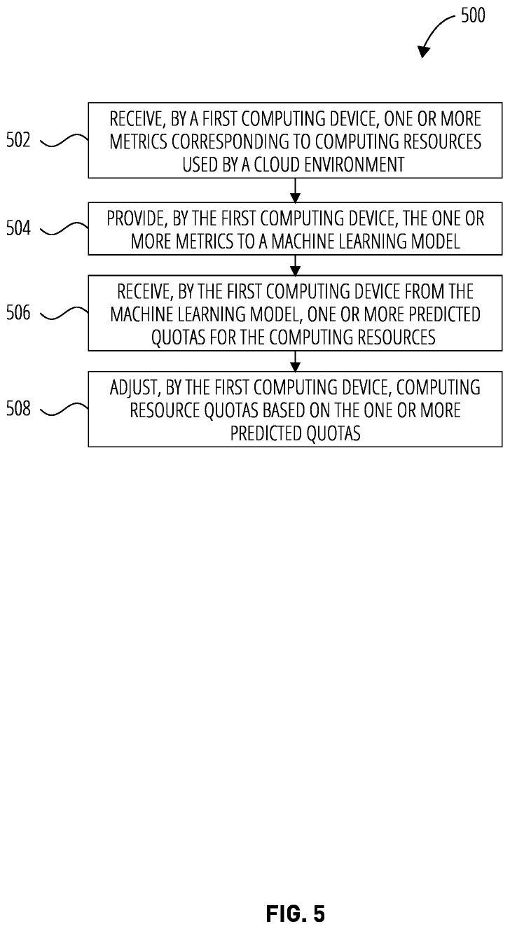

FIG. 5 is a flow chart 500 illustrating an example method of determining predicted quotas and updating computing resource quotas of a cloud environment. In block 502, a first computing device receives one or more metrics corresponding to computing resources used by a cloud environment. As explained herein, the one or more metrics may be provided by agents, such as agents 116. In block 504, the first computing device provides the one or more metrics to a machine learning model, such as quota prediction ML model 122. In block 506, the first computing device receives, from the machine learning model, one or more predicted quotas for the computing resources. In block 508, the first computing device updates computing resource quotas based on the one or more predicted quotas.

In this disclosure, the phrase “configured to” is used in different contexts related to computer systems, hardware, or part of a computer program, engine, or module. When a system is said to be configured to perform one or more operations, the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings, described in the specification, and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system, or be part of multiple systems.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (open-ended terminology).

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the example implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate one of many possible examples. Further, the same reference numbers in different drawings can identify the same or similar elements

What is claimed is:

1. A method for adjusting quotas, the method comprising:
receiving, by a first computing device, one or more metrics corresponding to computing resources used by a cloud environment;
providing, by the first computing device, the one or more metrics to a machine learning model;
receiving, by the first computing device from the machine learning model, one or more predicted quotas for the computing resources; and
adjusting, by the first computing device, computing resource quotas based on the one or more predicted quotas.

2. The method of claim 1, wherein the first computing device is a cloud service server.

3. The method of claim 1, wherein the computing resources are provided by a cloud service.

4. The method of claim 3, wherein the cloud environment is an application or website implemented by the computing resources of the cloud service.

5. The method of claim 1, wherein the one or more metrics include traffic volume of the cloud environment.

6. The method of claim 1, further comprising:
receiving, by the first computing device, business contexts data corresponding to the cloud environment, wherein the business contexts data is provided to the machine learning model.

7. The method of claim 6, wherein the business contexts data comprises business event data including information about upcoming sales, advertisements, or promotions being provided by a business associated with the cloud environment.

8. The method of claim 7, wherein the business event data is retrieved by a business event agent executing on the first computing device.

9. The method of claim 6, wherein the business contexts includes geographic event data including information corresponding to happenings in particular locales that may affect the cloud environment.

10. The method of claim 9, wherein the geographic event data is retrieved by a geo agent executing on the first computing device.

11. A computing apparatus comprising:
a processor; and
a memory storing instructions that, when executed by the processor, configure the apparatus to:
receive one or more metrics corresponding to computing resources used by a cloud environment;
provide the one or more metrics to a machine learning model;
receive from the machine learning model, one or more predicted quotas for the computing resources; and
adjust computing resource quotas based on the one or more predicted quotas.

12. The computing apparatus of claim 11, wherein the computing apparatus is a cloud service server.

13. The computing apparatus of claim 11, wherein the computing resources are provided by a cloud service.

14. The computing apparatus of claim 13, wherein the cloud environment is an application or website implemented by the computing resources of the cloud service.

15. The computing apparatus of claim 11, wherein the one or more metrics include traffic volume of the cloud environment.

16. The computing apparatus of claim 11, wherein the instructions further configure the apparatus to:
receive business contexts data corresponding to the cloud environment, wherein the business contexts data is provided to the machine learning model.

17. The computing apparatus of claim 16, wherein the business contexts data comprises business event data include information about upcoming sales, advertisements, or promotions being provided by a business associated with the cloud environment.

18. The computing apparatus of claim 17, wherein the business event data is retrieved by a business event agent.

19. The computing apparatus of claim 16, wherein the business contexts includes geographic event data include information corresponding to happenings in particular locales that may affect the cloud environment.

20. The computing apparatus of claim 19, wherein the geographic event data is retrieved by a geo agent.
